(19) United States
(12) Patent Application Publication
(10) Pub. No.: US 2026/0211577 A1
(43) Pub. Date: Jul. 23, 2026

(54) INTERFACE CIRCUITS, METHODS OF OPERATING THEREOF, MEMORY CONTROLLERS, SYSTEMS, AND DEVICES

(71) Applicant: YANGTZE MEMORY TECHNOLOGIES CO., LTD., Wuhan (CN)

(72) Inventor: Leiyu LUO, Wuhan (CN)

(21) Appl. No.: 19/236,687

(22) Filed: Jun. 12, 2025

(30) Foreign Application Priority Data
Jan. 21, 2025 (CN) 2025100961187

(51) Int. Cl. G06F 3/06

(52) U.S. Cl. CPC G06F 3/0655; G06F 3/061; G06F 3/0679

(57) ABSTRACT

An interface circuit includes a first communication circuit communicating with an external device based on a first protocol, a second communication circuit communicating with the external device based on a second protocol, and a switching circuit coupled to the first communication circuit and the second communication circuit and configured to enable the first communication circuit or the second communication circuit.

### CROSS-REFERENCE TO RELATED APPLICATIONS

The present disclosure claims priority to Chinese Patent Application No. 2025100961187, which was filed Jan. 21, 2025, and is hereby incorporated herein by reference in its entirety.

### TECHNICAL FIELD

The present disclosure relates to the field of integrated circuit technologies, and in particular, to interface circuits, methods of operating thereof, memory controllers, systems, and devices.

### BACKGROUND

In recent years, the integrated circuit industry has experienced rapid growth. Due to the increasing demand for high performance, high speed and multiple functions of electronic products in the consumer market, the use environment thereof has become more and more complicated. In the prior art, an interface protocol is usually used to exchange data information between a plurality of devices, to obtain a faster transmission rate, lower power consumption, and richer functions.

However, with continuous optimization and progress of interface protocols, it is inevitable that interface protocols supported by different devices may be different. Therefore, how to further improve compatibility of a device for different interface protocols becomes an urgent problem to be resolved in the industry.

### SUMMARY

An interface circuit, a method of operating thereof, a memory controller, a system, and a device are provided by present disclosure.

In a first aspect, the present disclosure provides an interface circuit, including:
a first communication circuit communicating with an external device based on a first protocol;
a second communication circuit communicating with the external device based on a second protocol;
a switching circuit coupled to the first communication circuit and the second communication circuit, and configured to enable the first communication circuit or the second communication circuit.

In some examples, the switching circuit is configured to:
in response to a first indication signal sent by the external device, enable the first communication circuit and disable the second communication circuit; or
in response to a second indication signal sent by the external device, enable the second communication circuit and disable the first communication circuit.

In some examples, the switching circuit includes:
a detection circuit coupled to the external device and configured to detect the first indication signal and the second indication signal sent by the external device; and
a control circuit coupled to the detection circuit and configured to enable the first communication circuit or the second communication circuit based on a signal detected by the detection circuit.

In some examples, the detection circuit includes:
a first detection circuit configured to: in response to the first indication signal, output a first detection signal;
a second detection circuit configured to: in response to the second indication signal, output a second detection signal;
the control circuit is configured to: in response to the first detection signal, enable the first communication circuit and disable the second communication circuit; or in response to the second detection signal, enable the second communication circuit and disable the first communication circuit.

In some examples, the interface circuit further includes:
an interface pad coupled to the external device;
a selection circuit coupled to the interface pad, the first communication circuit and the second communication circuit, and configured to gate a first signal path between the first communication circuit and the interface pad or a second signal path between the second communication circuit and the interface pad.

In some examples, the switching circuit is coupled to the selection circuit; and the switching circuit is further configured to: in response to the first indication signal, control the selection circuit to gate the first signal path; or in response to the second indication signal, control the selection circuit to gate the second signal path.

In some examples, the interface circuit further includes:
a power management circuit coupled to the interface pad and configured to provide a first power supply voltage or a second power supply voltage to the interface pad.

In some examples, the switching circuit is coupled to the power management circuit; and the switching circuit is further configured to: in response to the first indication signal, control the power management circuit to provide the first power supply voltage to the interface pad; or in response to the second indication signal, control the power management circuit to provide the second power supply voltage to the interface pad.

In some examples, the first indication signal and the second indication signal meet a specification requirement of the first protocol; or the first indication signal and the second indication signal meet a specification requirement of the second protocol.

In some examples, the first protocol is the SMBus protocol, and the second protocol is the I3C protocol; and the first indication signal includes a reset signal, and the second indication signal includes a 0×7E broadcast address.

In a second aspect, the present disclosure provides a memory controller, including an interface circuit and a processor configured to communicate with an external device through the interface circuit; where the interface circuit includes a first communication circuit, a second communication circuit and a switching circuit; where the switching circuit is coupled to the first communication circuit and the second communication circuit;
the first communication circuit is configured to communicate with the external device based on a first protocol;
the second communication circuit is configured to communicate with the external device based on a second protocol; and
the switching circuit is configured to: in response to a first indication signal sent by the external device, enable the first communication circuit and disable the second communication circuit; or in response to a second indication signal sent by the external device, enable the second communication circuit and disable the first communication circuit.

In some examples, the switching circuit includes:
a first detection circuit configured to: in response to the first indication signal, output a first detection signal;
a second detection circuit configured to: in response to the second indication signal, output a second detection signal;
a control circuit configured to: in response to the first detection signal, enable the first communication circuit and disable the second communication circuit; or in response to the second detection signal, enable the second communication circuit and disable the first communication circuit.

In some examples, the interface circuit further includes:
an interface pad coupled to the external device; and
a selection circuit coupled to the switching circuit, the interface pad, the first communication circuit and the second communication circuit; and
the switching circuit is further configured to: in response to the first indication signal, control the selection circuit to gate a first signal path between the first communication circuit and the interface pad; or in response to the second indication signal, control the selection circuit to gate a second signal path between the second communication circuit and the interface pad.

In some examples, the interface circuit further includes:
a power management circuit coupled to the switching circuit and the interface pad; and
the switching circuit is further configured to: in response to the first indication signal, control the power management circuit to provide a first power supply voltage to the interface pad; or in response to the second indication signal, control the power management circuit to provide a second power supply voltage to the interface pad.

In some examples, the first indication signal and the second indication signal meet a specification requirement of the first protocol; or the first indication signal and the second indication signal meet a specification requirement of the second protocol.

In a third aspect, the present disclosure provides a method of operating an interface circuit, where the interface circuit includes a first communication circuit communicating with an external device based on a first protocol and a second communication circuit communicating with the external device based on a second protocol; and the method of operating the interface circuit includes:
enabling the first communication circuit or the second communication circuit.

In some examples, the enabling the first communication circuit or the second communication circuit includes:
in response to a first indication signal sent by the external device, enabling the first communication circuit and disabling the second communication circuit; or in response to a second indication signal sent by the external device enabling the second communication circuit and disabling the first communication circuit.

In some examples, in response to a first indication signal sent by the external device enabling the first communication circuit and disabling the second communication circuit; or in response to a second indication signal sent by the external device enabling the second communication circuit and disabling the first communication circuit includes:
in response to the first indication signal outputting a first detection signal;
in response to the second indication signal outputting a second detection signal; and
in response to the first detection signal, enabling the first communication circuit and disabling the second communication circuit; or in response to the second detection signal, enabling the second communication circuit and disabling the first communication circuit.

In some examples, the method further includes:
in response to the first indication signal, gating a first signal path between the first communication circuit and an interface pad; or in response to the second indication signal, gating a second signal path between the second communication circuit and the interface pad.

In some examples, the method further includes:
in response to the first indication signal, providing a first power supply voltage to the interface pad; or in response to the second indication signal, providing a second power supply voltage to the interface pad.

In some examples, the first indication signal and the second indication signal meet a specification requirement of the first protocol; or the first indication signal and the second indication signal meet a specification requirement of the second protocol.

In a fourth aspect, the present disclosure provides a memory system, including: at least one memory device; and the memory controller described in any of the above examples coupled to the at least one memory device and configured to control the memory device.

In a fifth aspect, the present disclosure provides an electronic device, including the memory system described in the above examples.

In an example of the present disclosure, the switching circuit is coupled to the first communication circuit and the second communication circuit and enables one of the first communication circuit and the second communication circuit. Therefore, on one hand, the interface circuit can flexibly switch between the first protocol and the second protocol when communicating with the external device, thereby improving compatibility; and on the other hand, only one of the first communication circuit and the second communication circuit is enabled at the same time, thereby helping reduce power consumption of the interface circuit.

### BRIEF DESCRIPTION OF THE DRAWINGS

FIG. 1 is a schematic diagram of an example system with a memory system provided by an example of the present disclosure.

FIG. 2 is a schematic diagram of a memory card provided by an example of the present disclosure.

FIG. 3 is a schematic diagram of a solid state drive (SSD) provided by an example of the present disclosure.

FIG. 4 is a schematic diagram of another example system with a memory system provided by an example of the present disclosure.

FIG. 5 is a schematic diagram of an interface circuit provided by an example of the present disclosure.

FIG. 6 is a schematic diagram of another interface circuit provided by an example of the present disclosure.

FIG. 7 is a schematic diagram of another interface circuit provided by an example of the present disclosure.

FIG. 8 is a schematic diagram of a switching circuit in another interface circuit provided by an example of the present disclosure.

FIG. 9 is a schematic diagram of a selection circuit and a power management circuit in another interface circuit provided by an example of the present disclosure.

FIG. 10 is a flowchart of a method of operating an interface circuit provided by an example of the present disclosure.

### DETAILED DESCRIPTION

In order to facilitate understanding of the present disclosure, illustrated examples of the present disclosure will be described in more detail below with reference to the related drawings. Although the illustrated examples of the present disclosure are shown in the drawings, the present disclosure may be implemented in various forms and should not be limited to the examples set forth herein. On the contrary, these examples are provided to enable a more thorough understanding of the present disclosure and configured to fully convey the scope of the present disclosure to those skilled in the art.

In the following description, numerous specific details are set forth in order to provide a more thorough understanding of the present disclosure. However, it will be apparent to those skilled in the art that the present disclosure may be practiced without one or more of these details. In some examples, in order to avoid confusion with the present disclosure, some technical features known in the art are not described; for example, maybe not all the features of an actual example are described herein, and well-known functions and structures are not described in detail.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, a phrase “based on” may be understood as not necessarily intended to convey an exclusive set of factors and may, instead, allow for existence of additional factors not necessarily expressly described, again, depending at least in part on context.

Unless otherwise defined, the terminology used herein is for describing particular examples only and is not intended to be limitation of the disclosure. As used herein, the “a”, “an” and “the” in singular form are intended to include the plural form as well, unless the context clearly indicates otherwise. It will be further understood that the terms “comprising” and/or “including” when used in this specification, specify the presence of stated features, integers, operations, operations, elements, and/or components, but do not preclude the presence or addition of one or more other features, integers, operations, operations, elements, components, and/or groups thereof. As used herein, the term “and/or” includes any and all combinations of the relative listed items.

In order to thoroughly understand the present disclosure, detailed operations and detailed structures are provided in the following description to explain the technical solutions of the present disclosure. Preferred examples of the present disclosure are described in detail below, but the present disclosure may have other examples in addition to these described in detail.

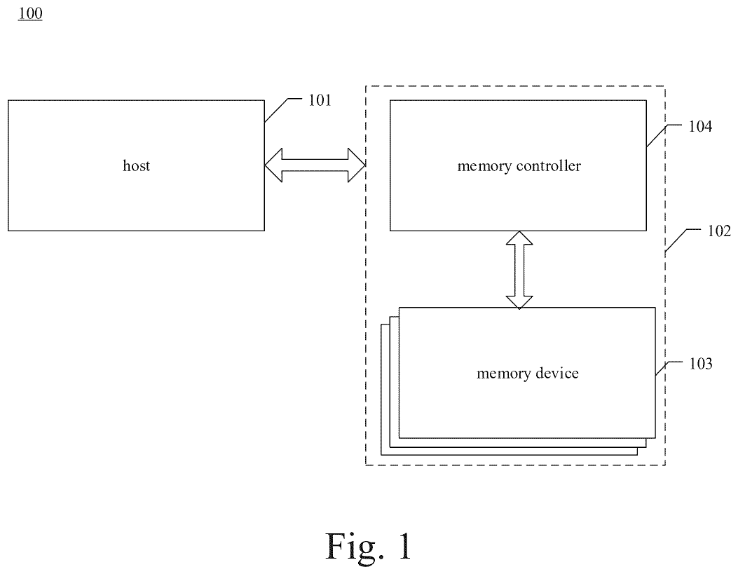

FIG. 1 is a schematic diagram of an example system with a memory system provided by an example of the present disclosure. In an example of the present disclosure, the system 100 may be a mobile phone, a desktop computer, a laptop computer, a tablet computer, a vehicle computer, a game console, a printer, a positioning device, a wearable electronic device, a smart sensor, a virtual reality (VR) device, an augmented reality (AR) device, or any other suitable electronic device having a memory therein. As shown in FIG. 1, system 100 may include a host 101 and a memory system 102, and memory system 102 may include one or more memory devices 103 and a memory controller 104. The host 101 may include a processor of the electronic device, such as a central processing unit (CPU), or a system on a chip (SoC), such as an application processor (AP). The host 101 may be configured to send data to the memory system 102 or receive data from the memory system 102.

In some examples, the memory controller 104 is coupled to the memory device 103 and the host 101, and is configured to control the memory device 103. Memory controller 104 can manage the data stored in memory device 103 and communicate with host 101. In some examples, the memory controller 104 is designed for operating in a low duty cycle environment, such as operating in a secure digital card, a compact flash card (CFCs), a universal serial bus (USB) flash drive, or other media for use in electronic devices such as personal calculators, digital cameras, mobile phones, etc. In some other examples, the memory controller 104 is designed for operating in a high duty cycle environment, such as operating in a solid-state drive or embedded Multi-Media Card (eMMC).

In some examples, the memory controller 104 and the one or more memory devices 103 may be integrated into various types of storage devices, for example, the memory system 102 may be implemented and packaged into different types of terminal electronic products.

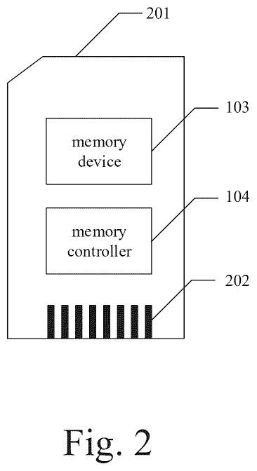

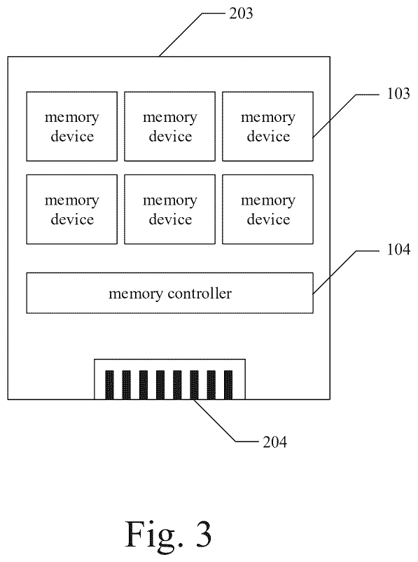

In one example as shown in FIG. 2, memory controller 104 and single memory device 103 may be integrated into memory card 201. The memory card 201 may be one of a compact flash card, a smart media card (SMC), a memory stick (MS), a multimedia card (MMC), such as RS-MMC, MMCmicro, eMMC, etc., a secure digital card, such as Mini SD card, Micro SD card, SDHC card, etc., and a universal flash card. Memory card 201 may also include a memory card connector 202 that couples memory card 201 with a host-side device (e.g., host 101 in FIG. 1). In another example as shown in FIG. 3, memory controller 104 and a plurality of memory devices 103 may be integrated into SSD 203. SSD 203 may also include an SSD connector 204 that couples SSD 203 with a host-side device (e.g., host 101 in FIG. 1). In some examples, the storage capacity and/or operating speed of the SSD 203 is greater than the storage capacity and/or operating speed of the memory card 201.

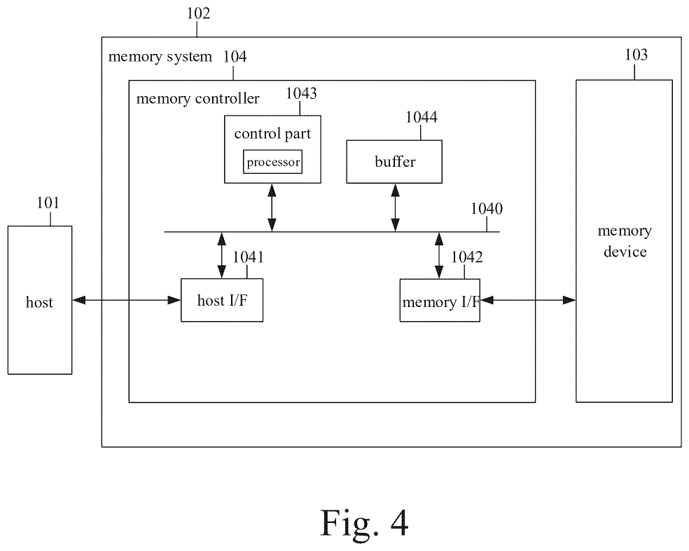

FIG. 4 is a schematic diagram of a system including a host and a memory system provided by an example of the present disclosed example, as shown in FIG. 4, the memory system 102 is connected to the host 101, where the memory system 102 may include a memory controller 104 and a memory device 103, the memory controller 104 is configured to control the memory device 103 to perform operations such as read, write and erase, and the memory controller 104 and the memory device 103 may also be coupled in any suitable manner. Memory controller 104 may include host interface (I/F) 1041, memory interface (I/F) 1042, control part 1043, buffer 1044, and bus 1040. The host interface 1041 is a connection interface connecting the host 101 and the memory controller 104, and the host interface 1041 allows the host 101 and the memory controller 104 to communicate according to a specific protocol, send a read request and a write request, and perform other operations. The memory interface 1042 is a connection interface between the memory controller 104 and the memory device 103, and the memory interface 1042 is configured to implement data transmission between the memory controller 104 and the memory device 103. The control part 1043 is configured to control the memory system 102 as a whole. In some examples, the control part 1043 may include one or more units having a logic operation capability, such as a central processing unit (CPU) and/or a microcontroller unit (MCU) and so on. In some examples, the buffer 1044 is configured to buffer data, and may be a volatile memory device with a relatively high read/write speed, such as a Static Random-Access Memory, SRAM and/or a Dynamic Random Access Memory, DRAM.

In an example of the present disclosure, the memory device in the memory system may include a NAND flash memory, but the interface circuit provided by the present disclosure is not limited to applications related to the NAND flash memory, and may be applied to other types of memory devices, such as an electrically erasable programmable read-only memory (EEPROM), a NOR flash memory, a phase change random access memory (PRAM), a magnetic RAM (MRAM), a resistive RAM (RRAM), a ferroelectric RAM (FRAM), etc. In some other examples, in addition to being applied to the memory, the interface circuit provided in the present disclosure may also be applied to any type of electronic device that communicates through an interface protocol, such as various sensors, processors, controllers, programmable logic devices, etc.

Currently, an SSD product based on a peripheral component interconnect express (PCIe) bus standard mainly uses the SMBus protocol as the device management interface protocol, but is changing to the I3C protocol, so that the SSD is required to support two interface protocols in a compatible manner. In an example, two independent communication circuits are usually configured to separately implement the SMBus protocol and the I3C protocol at SSD. When the host initiates an instruction for switching between the SMBus protocol and the I3C protocol, the SSD needs a mechanism to identify the instruction and switch to corresponding interface protocol to work.

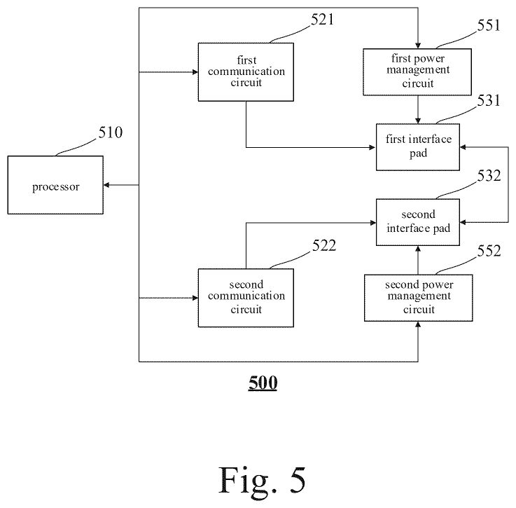

In some examples, FIG. 5 illustrates a schematic diagram of an interface circuit 500. For example, the interface circuit 500 may be located in a memory controller of the memory system and serve as a host interface of the memory controller. The interface circuit 500 includes a first communication circuit 521, a second communication circuit 522, a first interface pad 531, a second interface pad 532, a first power management circuit 551, and a second power management circuit 552. The processor 510 is coupled to and controls the first communication circuit 521, the second communication circuit 522, the first power management circuit 551, and the second power management circuit 552, and the processor 510 may be at least a part of the control part of the memory controller in the foregoing examples.

The first communication circuit 521 is coupled to the first interface pad 531, and configured to communicate with an external device through the first interface pad 531 based on a first protocol, here the external device may be a host, and the first protocol includes but is not limited to the SMBus protocol, I2C, the I3C protocol, and the like; and the second communication circuit 522 is coupled to the second interface pad 532, and configured to communicate with the external device through the second interface pad 532 based on a second protocol, the second protocol includes but is not limited to the SMBus protocol, I2C, the I3C protocol, and the like, and the second protocol is different from the first protocol. The first power management circuit 551 is configured to provide a first power supply voltage to the first interface pad 531, and the second power management circuit 552 is configured to provide a second power supply voltage to the second interface pad 532, for example, the first power management circuit 551 and the first interface pad 531 collaboratively perform the electrical connection of the first protocol at the chip package level, such as providing the first power supply voltage, a corresponding pull-up circuit, a push-pull circuit, etc.; and the second power management circuit 552 and the second interface pad 532 collaboratively perform the electrical connection of the second protocol at the chip package level, such as providing the second power supply voltage, a corresponding pull-up circuit, a push-pull circuit, etc. The processor 510 may control the first communication circuit 521 and/or the second communication circuit 522 to be enabled, and control the first power management circuit 551 and/or the second power management circuit 552 to provide a corresponding power supply voltage.

For example, in the SSD memory system, the first protocol may be the SMBus protocol, and the second protocol may be the I3C protocol. In this case, the processor 510 needs to simultaneously enable the first communication circuit 521 and the second communication circuit 522, and run protocol switching related firmware or a program, to implement detection of a protocol switching signal and query of status of the communication circuit, and the first interface pad 531 and the second interface pad 532 need to be shorted. In some examples, when the memory controller communicates with an external device (such as a host) with the SMBus protocol, the processor 510 enables the first communication circuit 521, to implement a function related to the SMBus protocol; because the first communication circuit 521 can only identify a signal in the SMBus protocol, and may not identify a 0×7E broadcast address for switching to the I3C protocol that is sent by the external device (the 0×7E broadcast address meets a specification requirement of the I3C protocol but does not meet a specification requirement of the SMBus protocol), the processor 510 further needs to simultaneously enable the second communication circuit 522, so that the 0×7E broadcast address can be identified in the SMBus mode, to implement the switching from the SMBus protocol to the I3C protocol. For example, the memory controller needs to simultaneously enable the first communication circuit 521 and the second communication circuit 522 in the SMBus mode. When the memory controller communicates with the external device with the I3C protocol, the processor 510 enables the second communication circuit 522 to implement a function related to the I3C protocol, and in this case, a reset signal for switching to the SMBus protocol that is sent by the external device may be identified by the second communication circuit 522 (the reset signal meets a specification requirement of the I3C protocol but does not meet the specification requirement of the SMBus protocol). For example, the memory controller is in the I3C mode, the processor 510 only needs to enable the second communication circuit 522, and does not need to enable the first communication circuit 521. Further, the first interface pad 531 and the second interface pad 532 need to implement electrical shorting of respective signals at the memory controller package level or board level to enable multiplexing of signal lines. It should be noted that, when switching between the two protocols is implemented, the memory controller requires the intervention by the processor 510, resulting in increased power consumption; the memory controller needs to simultaneously enable the first communication circuit 521 and the second communication circuit 522 in the SMBus mode, which further increases the power consumption of the memory system and increases the load capacitance of the bus; and the electrical short connection between the first interface pad 531 and the second interface pad 532 will cause an increase in the routing parasitic parameter of one of the first communication circuit 521 and the second communication circuit 522 for the other, which is easy to affect the electrical performance and even cause failure.

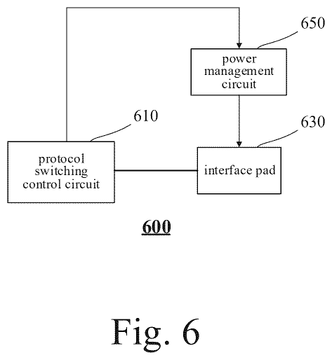

In some examples, FIG. 6 illustrates a schematic diagram of an interface circuit 600. For example, the interface circuit 600 may be located in a memory controller of the memory system, and serve as a host interface of the memory controller, the first protocol may be the SMBus protocol, and the second protocol may be the I3C protocol. The interface circuit 600 includes a protocol switching control circuit 610, an interface pad 630, and a power management circuit 650, and the protocol switching control circuit 610 may include the first communication circuit, the second communication circuit, and a related logic circuit in the foregoing examples. The protocol switching control circuit 610 needs to implement related functions of the SMBus protocol and the I3C protocol, and identify a protocol switching signal sent by an external device, to implement a switching function for the two protocols. In addition, the protocol switching control circuit 610 further needs to turn off the circuit related to the I3C protocol in the SMBus mode, and turn off the circuit related to the SMBus protocol in the I3C mode, to meet a low power consumption requirement. The power management circuit 650 is controlled by the protocol switching control circuit 610, and is responsible for power supply, pull-up and push-pull circuits for two protocols. The interface pad 630 implements the electrical conversion of the signal link of the protocol switching control circuit 610 to the chip package level. Therefore, the protocol switching control circuit 610 implements more functions, requires a new development and verification, which requires a large workload, and is difficult to implement low power consumption.

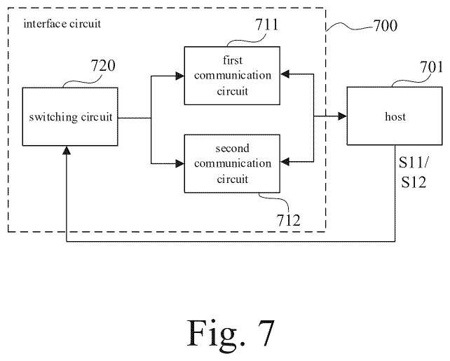

As shown in FIG. 7, the present disclosure provides an interface circuit 700, including: a first communication circuit 711 communicating with an external device 701 based on a first protocol; a second communication circuit 712 communicating with the external device 701 based on a second protocol; and a switching circuit 720, the switching circuit is coupled to the first communication circuit 711 and the second communication circuit 712 and configured to enable the first communication circuit 711 or the second communication circuit 712.

In an example of the present disclosure, the interface circuit 700 may be located in a memory controller of the memory system and serve as a host interface of the memory controller (referring to the host interface 1041 in FIG. 4), and it should be noted that the interface circuit 700 may also be configured for interfaces of other devices, which is not limited here. The interface circuit 700 includes at least a first communication circuit 711, a second communication circuit 712, and a switching circuit 720, and the switching circuit 720 is coupled to and controls the first communication circuit 711 and the second communication circuit 712. The first communication circuit 711 may communicate with the external device 701 through an interface pad (not shown in FIG. 7) based on a first protocol, here the external device 701 includes but is not limited to a host, and the first protocol includes but is not limited to the SMBus protocol, the I2C protocol, the I3C protocol, and the like; and the second communication circuit 712 may communicate with the external device 701 through an interface pad (not shown in FIG. 7) based on a second protocol, here the external device 701 includes but is not limited to a host, and the second protocol includes but is not limited to the SMBus protocol, the I2C protocol, the I3C protocol, and the like. In some examples, switching circuit 720 may be a logic circuit independent of the processor of a memory controller.

The switching circuit 720 may be implemented by an application-specific integrated circuit (ASIC), a DSP, a programmable logic device (PLD), a complex programmable logic device (CPLD), a field-programmable gate array (FPGA), or other simple logic gate circuits. When the interface circuit 700 needs to communicate with the external device 701 based on the first protocol, the switching circuit 720 enables the first communication circuit 711 and disables the second communication circuit 712; and when the interface circuit 700 needs to communicate with the external device 701 based on the second protocol, the switching circuit 720 enables the second communication circuit 712 and disables the first communication circuit 711.

For example, when the memory controller performs communication based on the SMBus protocol, the switching circuit 720 enables the first communication circuit 711 (the SMBus protocol communication circuit) and disables the second communication circuit 712 (the I3C protocol communication circuit); and when the memory controller performs communication based on the I3C protocol, the switching circuit 720 enables the second communication circuit 712 (the I3C protocol communication circuit) and disables the first communication circuit 711 (the SMBus protocol communication circuit). It may be understood that the switching circuit 720 may identify a 0×7E broadcast address for switching to the I3C protocol and a reset signal for switching to the SMBus protocol, to implement a corresponding protocol switching function.

For example, the switching circuit 720 is coupled to the first communication circuit 711 and the second communication circuit 712 and enables one of the first communication circuit 711 or the second communication circuit 712. Therefore, at one aspect, the interface circuit 700 can flexibly switch between the first protocol and the second protocol when communicating with the external device 701, thereby improving compatibility; at another aspect, only one of the first communication circuit 711 and the second communication circuit 712 is enabled at the same time, which is beneficial for reducing the power consumption of the interface circuit 700; at yet another aspect, the interface circuit 700 may execute corresponding firmware or programs for protocol switching without a processor, instead the interface circuit 700 may utilize a switching circuit 720 with simple logic, which is relatively easy to be implemented and has lower power consumption.

In some other examples, corresponding functions of the switching circuit 720 may also be implemented by a processor of the memory controller.

In some examples, as shown in FIG. 7, the switching circuit 720 is configured to: in response to a first indication signal S11 sent by the external device 701, enable the first communication circuit 711 and disable the second communication circuit 712; or in response to a second indication signal S12 sent by the external device 701 enable the second communication circuit 712 and disable the first communication circuit 711.

In an example of the present disclosure, the switching circuit 720 is further configured to identify the first indication signal S11 and the second indication signal S12 sent by the external device, the first indication signal S11 is to indicate the interface circuit 700 to switch to the first protocol for communication, and the second indication signal S12 is to indicate the interface circuit 700 to switch to the second protocol for communication. For example, the switching circuit 720 may identify the first indication signal S11 and the second indication signal S12, thereby in response to the first indication signal S11, enabling the first communication circuit 711 and disabling the second communication circuit 712, and configured to in response to the second indication signal S12, enable the second communication circuit 712 and disabling the first communication circuit 711.

It should be noted that, in the example shown in FIG. 5, the first communication circuit may not identify the 0×7E broadcast address, and the second communication circuit needs to remain enabled in both the two protocol modes, to identify the 0×7E broadcast address and the reset signal. In the example shown in FIG. 7, the switching circuit 720 does not have the foregoing limitation, and the switching circuit 720 may identify the first indication signal S11 and the second indication signal S12 in any protocol mode, so that only one of the first communication circuit 711 and the second communication circuit 712 is enabled at the same time, which helps to reduce power consumption of the interface circuit 700.

In some examples, the first indication signal S11 and the second indication signal S12 meet a specification requirement of the first protocol; or the first indication signal S11 and the second indication signal S12 meet a specification requirement of the second protocol.

In some examples, the first protocol is the SMBus protocol, and the second protocol is the I3C protocol; and the first indication signal S11 includes a reset signal, and the second indication signal S12 includes a 0×7E broadcast address.

The first indication signal S11 and the second indication signal S12 may both meet the specification requirement of the first protocol, in this case, if the first communication circuit 711 and the second communication circuit 712 are directly used to identify the first indication signal S11 and the second indication signal S12 (the switching circuit 720 is not used to identify the indication signal), when the interface circuit 700 may communicate with the external device based on the second protocol (the second communication circuit 712 is enabled) and the external device may send the first indication signal S11, the second communication circuit 712 may not identify the first indication signal S11, so the interface circuit 700 needs to enable the first communication circuit 711 and the second communication circuit 712 simultaneously in the second protocol mode to ensure normal switching from the second protocol to the first protocol, thereby increasing power consumption. Similarly, the first indication signal S11 and the second indication signal S12 may both meet the specification requirement of the second protocol, and if the first communication circuit 711 and the second communication circuit 712 are directly used to identify the first indication signal S11 and the second indication signal S12 (the switching circuit 720 is not used to identify the indication signal), in this case, the interface circuit 700 needs to enable the first communication circuit 711 and the second communication circuit 712 simultaneously in the first protocol mode to ensure normal switching from the first protocol to the second protocol, and at the same time, the power consumption is increased. Therefore, in the example of the present disclosure, since the switching circuit 720 can identify the first indication signal S11 and the second indication signal S12 in any protocol mode, only one of the first communication circuit 711 and the second communication circuit 712 is enabled at the same time, which is beneficial to reduce the power consumption of the interface circuit 700.

For example, the first protocol may be the SMBus protocol, and the second protocol may be the I3C protocol; the first indication signal S11 may include a reset signal, and the second indication signal S12 may include a 0×7E broadcast address, where both the reset signal and the 0×7E broadcast address meet a specification requirement of the I3C protocol, but do not meet the specification requirement of the SMBus protocol.

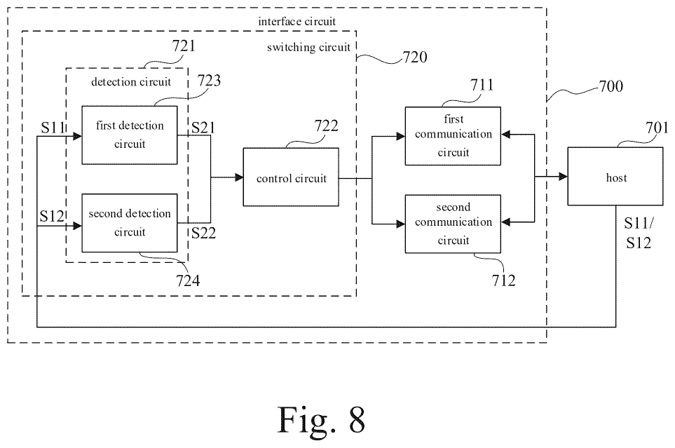

In some examples, as shown in FIG. 8, the switching circuit 720 includes: a detection circuit 721 coupled to the external device 701 and configured to detect the first indication signal S11 and the second indication signal S12 sent by the external device 701; and a control circuit 722 coupled to the detection circuit 721 and configured to enable the first communication circuit 711 or the second communication circuit 712 based on a signal detected by the detection circuit 721.

In an example of the present disclosure, the switching circuit 720 includes a detection circuit 721 and a control circuit 722. The detection circuit 721 is configured to detect a first indication signal S11 and a second indication signal S12 sent by the external device 701. For example, the detection circuit 721 may be configured to detect the second indication signal S12 in the first protocol mode, detect the first indication signal S11 in the second protocol mode, and feedback the corresponding detection result to the control circuit 722. The detection circuit 721 may include circuits such as transmission start detection, a serial-to-parallel conversion circuit, level detection, and a timer.

The control circuit 722 is configured to control enabling and disabling of the first communication circuit 711 and the second communication circuit 712. For example, in response to the detection circuit 721 detecting the second indication signal S12 in the first protocol mode, the control circuit 722 enables the second communication circuit 712 and disables the first communication circuit 711, thereby implementing the switching from the first protocol to the second protocol; in response to the detection circuit 721 detecting the first indication signal S11 in the second protocol mode, the control circuit 722 enables the first communication circuit 711 and disables the second communication circuit 712, thereby implementing the switching from the second protocol to the first protocol.

In some examples, as shown in FIG. 8, the detection circuit 721 includes: a first detection circuit 723 configured to: in response to the first indication signal S11, output a first detection signal S21; a second detection circuit 724 configured to: in response to the second indication signal S12, output a second detection signal S22; and the control circuit 722 is configured to: in response to the first detection signal S21, enable the first communication circuit 711 and disable the second communication circuit 712; or in response to the second detection signal S22, enable the second communication circuit 712 and disable the first communication circuit 711.

In an example of the present disclosure, the detection circuit 721 includes a first detection circuit 723 and a second detection circuit 724. When detecting the first indication signal S11, the first detection circuit 723 outputs a first detection signal S21; and when detecting the second indication signal S12, the second detection circuit 724 outputs a second detection signal S22.

For example, in the memory controller, the first detection circuit 723 of the interface circuit 700 may be configured to detect the reset signal (the first indication signal S11) sent by the host in the I3C protocol mode (the second protocol mode), and when detecting the reset signal, the first detection circuit 723 outputs the first detection signal S21 to the control circuit 722, the first detection circuit 723 may have functions such as level detection and a timer, and so on, and the reset signal sent by the host herein includes but is not limited to clock signal pull down, an SMB_RST signal, and other forms. The second detection circuit 724 of the interface circuit 700 may be configured to detect the 0×7E broadcast address (the second indication signal S12) in the SMBus protocol mode (the first protocol mode), and when detecting the 0×7E broadcast address, the second detection circuit 724 outputs a second detection signal S22 to the control circuit 722, and replies an acknowledgement (ACK) signal to the host, and the second detection circuit 724 may include a transmission start detection circuit and a serial-to-parallel conversion circuit, etc., as desired.

The control circuit 722 receives the first detection signal S21 output by the first detection circuit 723, and the second detection signal S22 output by the second detection circuit 724, and after a simple logic determination, the control circuit 722 outputs an execution signal to the first communication circuit 711 and the second communication circuit 712 to enable one of the first communication circuit 711 and the second communication circuit 712 and disable the other one. For example, the control circuit 722 enables the first communication circuit 711 and disables the second communication circuit 712 in response to the first detection signal S21, thereby implementing the switching from the second protocol to the first protocol; and the control circuit 722 enables the second communication circuit 712 and disables the first communication circuit 711 in response to the second detection signal S22, thereby implementing the switching from the first protocol to the second protocol. In some examples, control circuit 722 supports programmable configuration inputs.

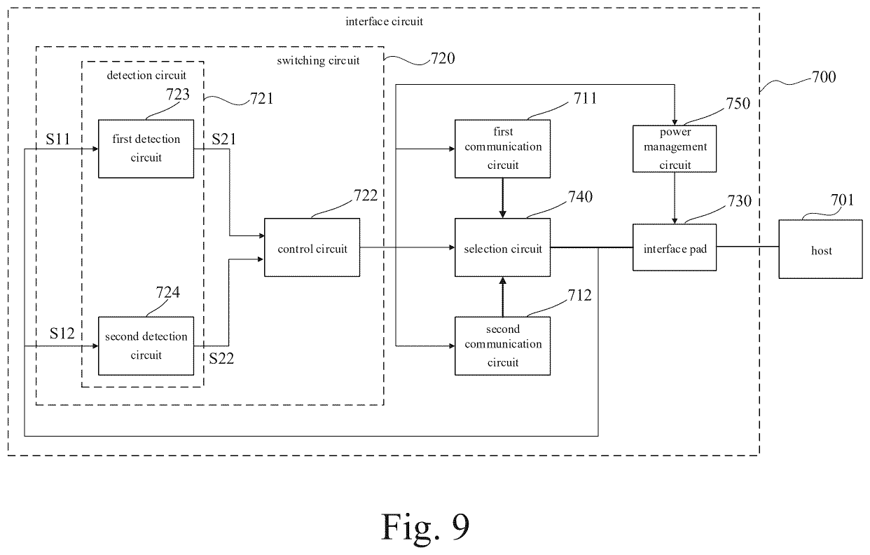

In some examples, as shown in FIG. 9, the interface circuit 700 further includes: an interface pad 730 coupled to the external device 701; a selection circuit 740 coupled to the interface pad 730, the first communication circuit 711, and the second communication circuit 712; and the selection circuit 740 gates a first signal path between the first communication circuit 711 and the interface pad 730 or a second signal path between the second communication circuit 712 and the interface pad 730.

In an example of the present disclosure, the interface circuit 700 further includes the interface pad 730 and the selection circuit 740, the interface pad 730 is configured to implement electrical connection at the chip packaging level, that is coupled to the external device 701; and the first communication circuit 711 and the second communication circuit 712 are coupled to the interface pad 730 through the selection circuit 740.

The selection circuit 720 may be configured to gate the first signal path between the first communication circuit 711 and the interface pad 730 in the first protocol mode, so that the interface circuit 700 communicates with the external device 701 based on the first protocol; and the selection circuit 720 may be further configured to gate the second signal path between the second communication circuit 712 and the interface pad 730 in the second protocol mode, so that the interface circuit 700 communicates with the external device 701 based on the second protocol. For example, the selection circuit 720 may be implemented by a multiplexer and other related logic circuits. Therefore, the selection circuit 720 may cause the interface pad 730 to be connected to one of the first communication circuit 711 and the second communication circuit 712 at the same time, for example, to ensure that there is only one hardware connection of the signal link at the same time, without causing any electrical compatibility problem.

In some examples, as shown in FIG. 9, the switching circuit 720 is coupled to the selection circuit 740; and the switching circuit 720 is further configured to: in response to the first indication signal S11, control the selection circuit 740 to gate the first signal path; or in response to the second indication signal S12, control the selection circuit 740 to gate the second signal path.

In an example of the present disclosure, the selection circuit 740 may be controlled by the switching circuit 720 to gate the first signal path or the second signal path. For example, when detecting the first indication signal S11, the first detection circuit 723 outputs a first detection signal S21, and in response to the first detection signal S21, the control circuit 722 controls the selection circuit 740 to gate the first signal path between the first communication circuit 711 and the interface pad 730; and when detecting the second indication signal S12, the second detection circuit 724 outputs a second detection signal S22, and in response to the second detection signal S22, the control circuit 722 controls the selection circuit 740 to gate the second signal path between the second communication circuit 712 and the interface pad 730.

In some examples, as shown in FIG. 9, the interface circuit 700 further includes: a power management circuit 750 coupled to the interface pad 730 and configured to provide a first power supply voltage or a second power supply voltage to the interface pad 730.

In an example of the present disclosure, the power management circuit 750 may be configured to switch different IO voltages and pull-down configurations in the first protocol mode or the second protocol mode. For example, the power management circuit 750 may be configured to provide the first power supply voltage to the interface pad 730 in the first protocol mode, or provide the second power supply voltage to the interface pad 730 in the second protocol mode. In some examples, the power management circuit 750 provides a power supply voltage of 1.8v or 3.3v to the interface pad 730 and provides a corresponding pull-up circuit in the SMBus protocol mode; and the power management circuit 750 provides a power supply voltage of 1.8v to the interface pad 730 and provides a corresponding pull-up circuit and a push-pull circuit in the I3C protocol mode.

In some examples, as shown in FIG. 9, the switching circuit 720 is coupled to the power management circuit 750; and the switching circuit 720 is further configured to: in response to the first indication signal S11, control the power management circuit 750 to provide the first power supply voltage to the interface pad 730; or in response to the second indication signal S12, control the power management circuit 750 to provide the second power supply voltage to the interface pad 730.

In an example of the present disclosure, the power management circuit 750 may be controlled by the switching circuit 720 to provide a power supply voltage and a pull-up/pull-down configuration corresponding to a protocol. For example, when detecting the first indication signal S11, the first detection circuit 723 outputs a first detection signal S21, and in response to the first detection signal S21, the control circuit 722 controls the power management circuit 750 to provide the first power supply voltage to the interface pad 730; and when detecting the second indication signal S12, the second detection circuit 724 outputs a second detection signal S22, and in response to the second detection signal S22, the control circuit 722 controls the power management circuit 750 to provide the second power supply voltage to the interface pad 730.

In some examples, the first detection circuit 723, the second detection circuit 724, and the control circuit 722 need to be always in the power domain, for example, maintain power supply of the foregoing three circuits, to implement continuous detection and control. Therefore, the first detection circuit 723, the second detection circuit 724, and the control circuit 722 need to be designed with low power consumption.

The present disclosure provides a memory controller including an interface circuit and a processor configured to communicate with an external device through the interface circuit; where the interface circuit includes a first communication circuit, a second communication circuit and a switching circuit; where the switching circuit is coupled to the first communication circuit and the second communication circuit; the first communication circuit is configured to communicate with the external device based on a first protocol; the second communication circuit is configured to communicate with the external device based on a second protocol; and the switching circuit is configured to: in response to a first indication signal sent by the external device, enable the first communication circuit and disable the second communication circuit; or in response to a second indication signal sent by the external device, enable the second communication circuit and disable the first communication circuit.

In an example of the present disclosure, the memory controller may be understood with reference to the example corresponding to FIG. 4, and details are not described herein again. It should be noted that, in this example, the switching circuit may be a logic circuit independent of the processor of the memory controller, for example, switching between the first protocol and the second protocol does not require involvement of the processor of the memory controller.

Therefore, at one aspect, when communicating with the external device, the interface circuit can flexibly switch between the first protocol and the second protocol, thereby improving compatibility; at another aspect, only one of the first communication circuit and the second communication circuit is enabled at the same time, which is beneficial for reducing the power consumption of the interface circuit; at yet another aspect, the interface circuit may execute corresponding firmware or programs without a processor, to achieve protocol switching, but instead utilizes a switching circuit with simple logic, which is relatively easy to be implemented and has lower power consumption.

In some examples, the switching circuit includes: a first detection circuit configured to in response to the first indication signal, output a first detection signal; a second detection circuit configured to in response to the second indication signal, output a second detection signal; and a control circuit configured to: in response to the first detection signal, enable the first communication circuit and disable the second communication circuit; or in response to the second detection signal, enable the second communication circuit and disable the first communication circuit.

In some examples, the interface circuit further includes: an interface pad coupled to the external device; and a selection circuit coupled to the switching circuit, the interface pad, the first communication circuit, and the second communication circuit; and the switching circuit is further configured to: in response to the first indication signal, control the selection circuit to gate a first signal path between the first communication circuit and the interface pad; or in response to the second indication signal, control the selection circuit to gate a second signal path between the second communication circuit and the interface pad.

In some examples, the interface circuit further includes: a power management circuit coupled to the switching circuit and the interface pad; and the switching circuit is further configured to: in response to the first indication signal, control the power management circuit to provide a first power supply voltage to the interface pad; or in response to the second indication signal, control the power management circuit to provide a second power supply voltage to the interface pad.

In some examples, the first indication signal and the second indication signal meet a specification requirement of the first protocol; or the first indication signal and the second indication signal meet a specification requirement of the second protocol.

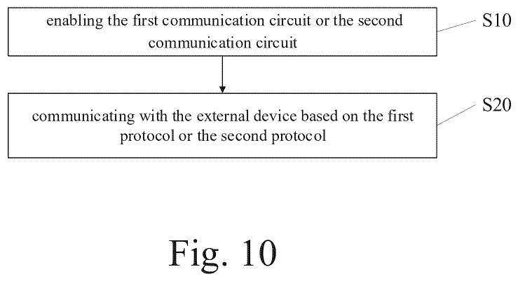

The present disclosure provides a method of operating an interface circuit, where the interface circuit includes a first communication circuit communicating with an external device based on a first protocol and a second communication circuit communicating with the external device based on a second protocol. As shown in FIG. 10, the method of operating the interface circuit includes the following operations:
operation S10: enabling the first communication circuit or the second communication circuit;
operation S20: communicating with the external device based on the first protocol or the second protocol.

The operations illustrated in FIG. 10 are not exclusive and that other operations may be performed before, after, or between any of the operations in the illustrated operations.

In some examples, the enabling the first communication circuit or the second communication circuit includes: in response to a first indication signal sent by the external device, enabling the first communication circuit and disabling the second communication circuit; or in response to a second indication signal sent by the external device, enabling the second communication circuit and disabling the first communication circuit.

In some examples, in response to a first indication signal sent by the external device, enabling the first communication circuit and disabling the second communication circuit; or in response to a second indication signal sent by the external device, enabling the second communication circuit and disabling the first communication circuit includes: in response to the first indication signal, outputting a first detection signal; in response to the second indication signal, outputting a second detection signal; in response to the first detection signal, enabling the first communication circuit and disabling the second communication circuit; or in response to the second detection signal, enabling the second communication circuit and disabling the first communication circuit.

In some examples, the method further includes: in response to the first indication signal, gating a first signal path between the first communication circuit and an interface pad; or in response to the second indication signal, gating a second signal path between the second communication circuit and the interface pad.

In some examples, the method further includes: in response to the first indication signal, providing a first power supply voltage to the interface pad; or in response to the second indication signal, providing a second power supply voltage to the interface pad.

In some examples, the first indication signal and the second indication signal meet a specification requirement of the first protocol; or the first indication signal and the second indication signal meet a specification requirement of the second protocol.

The present disclosure provides a memory system, including: at least one memory device; and the memory controller described in any of the above examples coupled to the at least one memory device and configured to control the memory device.

In an example of the present disclosure, the memory system may correspond to the memory system 102 in the example shown in FIG. 4, the memory device may correspond to the memory device 103 in the example shown in FIG. 4, and the memory controller may correspond to the memory controller 104 in the example shown in FIG. 4, which will not be repeated here again.

The present disclosure provides an electronic device, including the memory system described in the above examples.

In an example of the present disclosure, the electronic device may be correspondingly understood with reference to the system 100 in the example shown in FIG. 1, which will not be repeated here again. The system 100 may be implemented by the memory system 102 in the foregoing examples, one or more application-specific integrated circuits (ASIC), a DSP, a programmable logic device (PLD), a complex programmable logic device (CPLD), a field-programmable gate array (FPGA), a general-purpose processor, a controller, a micro controller unit (MCU), a microprocessor, or other electronic elements.

In the interface circuit, the method of operating thereof, the memory controller, the memory system and the electronic device provided by the present disclosure, at one aspect, when communicating with the external device, the interface circuit can flexibly switch between the first protocol and the second protocol, thereby improving the compatibility; at another aspect, only one of the first communication circuit and the second communication circuit is enabled at the same time, which is beneficial to reduce the power consumption of the interface circuit; at yet another aspect, the interface circuit may execute corresponding firmware or programs to implement protocol switching without a processor, but instead utilizes a switching circuit with simple logic, which is relatively easy to implement and has lower power consumption; at still another aspect, the selection circuit can enable the interface pad to be connected to one of the first communication circuit and the second communication circuit at the same time, for example, to ensure that there is only one hardware connection of the signal link at the same time, without causing any electrical compatibility problem.

“One example” or “an example” mentioned throughout the specification means that particular features, structures, or characteristics related to the example are included in at least one example of the present disclosure. Therefore, “in one example” or “in an example” appearing throughout the specification does not necessarily refer to the same example. Furthermore, the features, structures, or characteristics herein may be combined in any suitable manner in one or more examples. In various examples of the present disclosure, the sequence numbers of the above processes do not mean an execution sequence, and the execution sequence of respective processes should be determined by its function and internal logic, and should not constitute any limitation on the example process of the examples of the present disclosure. The sequence numbers of the above examples of the present disclosure are only for description, and do not represent the preference of the examples.

The examples described above are only preferred examples of the present disclosure and do not limit the patent scope of the present disclosure. Any equivalent structural transformation which is made under the inventive concept of the present disclosure using the contents of specification and drawings in the present disclosure, or directly/indirectly applied in other related technical fields, is included in the patent scope of the present disclosure.

What is claimed is:

1. An interface circuit, including:
a first communication circuit configured to communicate with an external device based on a first protocol;
a second communication circuit configured to communicate with the external device based on a second protocol; and
a switching circuit coupled to the first communication circuit and the second communication circuit and configured to enable the first communication circuit or the second communication circuit.

2. The interface circuit of claim 1, wherein the switching circuit is configured to:
in response to receiving a first indication signal from the external device, enable the first communication circuit and disable the second communication circuit; and
in response to receiving a second indication signal from the external device, enable the second communication circuit and disable the first communication circuit.

3. The interface circuit of claim 2, wherein the switching circuit includes:
a detection circuit coupled to the external device and configured to detect the first indication signal and the second indication signal sent by the external device; and
a control circuit coupled to the detection circuit and configured to enable the first communication circuit or the second communication circuit based on a signal detected by the detection circuit.

4. The interface circuit of claim 3, wherein the detection circuit includes:
a first detection circuit configured to, in response to the first indication signal, output a first detection signal; and
a second detection circuit configured to, in response to the second indication signal, output a second detection signal,
wherein the control circuit is configured to:
in response to receiving the first detection signal, enable the first communication circuit and disable the second communication circuit; and
in response to receiving the second detection signal, enable the second communication circuit and disable the first communication circuit.

5. The interface circuit of claim 2, further including:
an interface pad coupled to the external device; and
a selection circuit coupled to the interface pad, the first communication circuit and the second communication circuit, wherein the selection circuit is configured to gate a first signal path between the first communication circuit and the interface pad or a second signal path between the second communication circuit and the interface pad.

6. The interface circuit of claim 5, wherein the switching circuit is coupled to the selection circuit and is further configured to:
in response to receiving the first indication signal, control the selection circuit to gate the first signal path; and
in response to receiving the second indication signal, control the selection circuit to gate the second signal path.

7. The interface circuit of claim 5, further including a power management circuit coupled to the interface pad and configured to provide a first power supply voltage or a second power supply voltage to the interface pad.

8. The interface circuit of claim 7, wherein the switching circuit is coupled to the power management circuit and is further configured to:
in response to receiving the first indication signal, control the power management circuit to provide the first power supply voltage to the interface pad; and
in response to receiving the second indication signal, control the power management circuit to provide the second power supply voltage to the interface pad.

9. The interface circuit of claim 2, wherein the first indication signal and the second indication signal meet a specification requirement of the first protocol, or wherein the first indication signal and the second indication signal meet a specification requirement of the second protocol.

10. The interface circuit of claim 9, wherein the first protocol is a SMBus protocol and the second protocol is an I3C protocol, wherein the first indication signal includes a reset signal, and wherein the second indication signal includes a 0×7E broadcast address.

11. A memory controller, including:
a processor configured to communicate with an external device through an interface circuit; and
the interface circuit, including:
a first communication circuit configured to communicate with the external device based on a first protocol;
a second communication circuit configured to communicate with the external device based on a second protocol; and
a switching circuit coupled to the first communication circuit and the second communication circuit and configured to:
in response to receiving a first indication signal from the external device, enable the first communication circuit and disable the second communication circuit; and
in response to receiving a second indication signal from the external device, enable the second communication circuit and disable the first communication circuit.

12. The memory controller of claim 11, wherein the switching circuit includes:
a first detection circuit configured to, in response to the first indication signal, output a first detection signal;
a second detection circuit configured to, in response to the second indication signal, output a second detection signal; and
a control circuit coupled to the first detection circuit configured to:
in response to receiving the first detection signal, enable the first communication circuit and disable the second communication circuit; and
in response to receiving the second detection signal, enable the second communication circuit and disable the first communication circuit.

13. The memory controller of claim 11, wherein the interface circuit further includes:
an interface pad coupled to the external device; and
a selection circuit coupled to the switching circuit, the interface pad, the first communication circuit and the second communication circuit, and
wherein the switching circuit is further configured to:
in response to receiving the first indication signal, control the selection circuit to gate a first signal path between the first communication circuit and the interface pad; and
in response to receiving the second indication signal, control the selection circuit to gate a second signal path between the second communication circuit and the interface pad.

14. The memory controller of claim 13, wherein the interface circuit further includes a power management circuit coupled to the switching circuit and the interface pad, wherein the switching circuit is further configured to:
in response to receiving the first indication signal, control the power management circuit to provide a first power supply voltage to the interface pad; and
in response to receiving the second indication signal, control the power management circuit to provide a second power supply voltage to the interface pad.

15. The memory controller of claim 11, wherein the first indication signal and the second indication signal meet a specification requirement of the first protocol, or wherein the first indication signal and the second indication signal meet a specification requirement of the second protocol.

16. A method of operating an interface circuit including a first communication circuit configured to communicate with an external device based on a first protocol and a second communication circuit configured to communicate with the external device based on a second protocol, the method of operating the interface circuit including enabling the first communication circuit or the second communication circuit.

17. The method of claim 16, wherein enabling the first communication circuit or the second communication circuit includes:
in response to receiving a first indication signal from the external device, enabling the first communication circuit and disabling the second communication circuit; or
in response to receiving a second indication signal from the external device, enabling the second communication circuit and disabling the first communication circuit.

18. The method of claim 17, wherein enabling the first communication circuit and disabling the second communication circuit or enabling the second communication circuit and disabling the first communication circuit includes:
in response to receiving the first indication signal, outputting a first detection signal; or
in response to receiving the second indication signal, outputting a second detection signal; and
in response to receiving the first detection signal, enabling the first communication circuit and disabling the second communication circuit; or
in response to receiving the second detection signal, enabling the second communication circuit and disabling the first communication circuit.

19. The method of claim 17, further including:
in response to receiving the first indication signal, gating a first signal path between the first communication circuit and an interface pad; or
in response to receiving the second indication signal, gating a second signal path between the second communication circuit and the interface pad.

20. The method of claim 19, further including:
in response to receiving the first indication signal, providing a first power supply voltage to the interface pad; or
in response to receiving the second indication signal, providing a second power supply voltage to the interface pad.
